(19) United States
(12) Patent Application Publication
(10) Pub. No.: US 2012/0214374 A1
(43) Pub. Date: Aug. 23, 2012

(54) PAPER MACHINE CLOTHING HAVING MONOFILAMENTS WITH LOWER COEFFICIENT OF FRICTION

(76) Inventors: Chaitra Mahesha, Summerville, SC (US); Juergen Abraham, Nattheim (DE); Brian Good, Summerville, SC (US)

(21) Appl. No.: 13/031,432

(22) Filed: Feb. 21, 2011

(51) Int. Cl. D03D 15/00; C08K 5/27; C08L 67/02; D01D 5/12; D02G 3/02

(52) U.S. Cl. 442/189; 442/199; 264/210.8; 428/401; 524/538; 524/190

(57) ABSTRACT

A PMC fabric yarn, for use in a PMC fabric, has a composition which is a mixture of between 75% to 99% PET, 1% to 20% polymeric siloxane, and with a remainder of the composition being between 0.1% to 5% compatibilizer.

### BACKGROUND OF THE INVENTION

1. Field of the Invention

The present invention relates to paper machine clothing, and, more particularly, to the composition of monofilaments used in paper machine clothing.

2. Description of the Related Art

A paper machine clothing (PMC) fabric is typically carried by a number of rolls in a paper machine, and travels at a high speed. Vacuum boxes are used to pull moisture from the web through the PMC. This creates multiple friction points within the paper machine that wears down the PMC fabric and increases power consumption. The individual yarns making up a PMC fabric require several desirable physical properties, such as modulus of elasticity, relative elongation, abrasion resistance, fibrillation resistance, and a low coefficient of friction.

Polyethylene terephthalate (PET) is widely used in the fiber and monofilament industry for its good mechanical properties but sometimes has to be modified to improve its abrasion and fibrillation resistance. Different modifying techniques have been used to achieve these improvements. A well-known method is to utilize higher molecular weight PET resin. But the techniques used to increase the molecular weight of the PET resin are time consuming and hence not very efficient. Other approaches include modifications of PET. One such modification incorporates fluoropolymer into PET melt to form fibers with increased wear resistance (see, e.g., U.S. Pat. Pub. No. 20100068516). In another method, polydialkyl siloxane is incorporated in PET during the synthesis stage to form a linear-silicone modified PET and subsequently processed into a monofilament with higher fibrillation resistance (see, e.g., U.S. Pat. No. 5,922,463) and soil repellence (see, e.g., U.S. Pat. No. 5,759,685). The focus of U.S. Pat. Nos. 5,922,463 and 5,759,685 is the use of a poly-condensation reaction between polydialkyl siloxane and PET to create the silicone modified PET. This limits the flexibility and ease of controlling the final composition of the monofilaments during the extrusion process. U.S. Pat. No. 5,759,685 does briefly mention the possibility of using a pure PET resin and adding polydimethyl siloxane upstream of the extruder via a metering device; however, when put into practice this led to processing issues due to phase separation of the two materials. In addition to these improvements to PET, sometimes when applicable the fabrics are woven with a combination of PET and Polyamide (PA), especially PA-6 and PA-6.6 yarns to improve the wear resistance of the final product. Incorporation of PA yarns lowers the dimensional stability of the fabrics as polyamides are prone to moisture/water absorption. Especially when these fabrics are used as paper machine clothing, the water absorption leads to higher friction between the fabrics and the rolls, thereby increasing power consumption.

What is needed in the art is a PET monofilament yarn for a PMC fabric that has improved abrasion resistance, reduced coefficient of friction, and can be processed in a continuous manner.

### SUMMARY OF THE INVENTION

The present invention provides an environmentally friendly monofilament with increased wear resistance and/or lower co-efficient of friction for industrial textiles, more specifically for paper machine clothing. Such a yarn can then be woven into a paper machine clothing which would provide less resistance to roll drives of the paper machine and hence reduce power consumption. Especially in the forming section, high vacuum may sometimes be applied to achieve a higher dry content in the product leaving this section. The fabric made from a monofilament of the current invention will then undergo less wear than a standard fabric and hence may provide the opportunity to apply higher vacuum and/or achieve faster production speeds without any significant increase in power consumption.

The monofilament of the current invention is a non-fluoropolymer modification and hence environmentally friendly. The modification is carried out by incorporating the polymeric siloxane during the monofilament production process rather than in the polymerization phase. In addition, a compatibilizer is used to improve the processability of the blend by bonding the resin with the polymeric siloxane. Thus, it provides more flexibility and ease in controlling the final composition of the monofilaments and hence their properties.

The invention in one form is directed to a PMC fabric yarn for use in a PMC fabric, with the PMC yarn having a composition which is a mixture of between 75% to 99% PET, 1% to 20% polymeric siloxane, and the remainder of the composition being between 0.1% to 5% compatibilizer.

The invention in another form is directed a method of manufacturing a PMC fabric yarn for use in a PMC fabric. The method includes the steps of: melt blending a mixture of between 75% to 99% PET, 1% to 20% polymeric siloxane, and the remainder of said mixture being between 0.1% to 5% compatibilizer; spinning the mixture into a filament; and drawing the filament into a monofilament PMC fabric yarn with at least one predetermined physical property.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a fragmentary, perspective view of a portion of a fabric including an embodiment of a monofilament yarn of the present invention; and

FIG. 2 is a flowchart illustrating an embodiment of the method of making monofilament yarns of the present invention.

Corresponding reference characters indicate corresponding parts throughout the several views. The exemplification set out herein illustrates an embodiment of the invention, in one form, and such exemplification is not to be construed as limiting the scope of the invention in any manner.

### DETAILED DESCRIPTION OF THE INVENTION

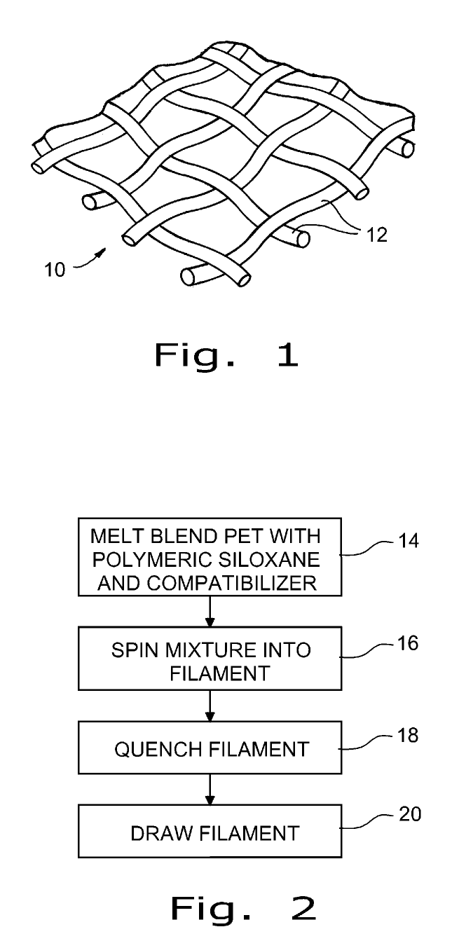

Referring now to the drawings, and more particularly to FIG. 1, there is shown a portion of an embodiment of a PMC fabric 10 including a plurality of woven monofilament yarns 12. Yarns 12 have a diameter of between approximately 0.05 mm and 0.9 mm, but this may vary between applications. The specific configuration of fabric 10 may vary, depending upon the application. For example, the specific weave pattern of fabric 10 may vary from one application to another. Moreover, fabric 10 need not necessarily be a woven fabric, but may include non-woven yarns 12.

At least some of the yarns 12 making up fabric 10 have a composition which is a mixture of between 75% to 99% PET, 1% to 20% polymeric siloxane, and the remainder of the composition being between 0.1% to 5% compatibilizer. Preferably, yarns 12 have a composition with between 2% to 6% polymeric siloxane. In addition to polymeric siloxane and PET resin, the blend also has a compatibilizer or process aid which improves processibility of the blend to produce monofilaments continuously in a typical production setup and helps reduce phase separation between the polymeric siloxane and PET resin. An example of such a compatibilizer is carbodiimide. It can be incorporated in its pure form or as a Masterbatch. The active compatibilizer content is between 0.1% to 5%, preferably between 0.1% to 1% of the total mixture.

PMC yarns 12 have an increased abrasion resistance and/or lower co-efficient of friction. This is accomplished by melt blending PET resin with polymeric siloxane and the compatibilizer, spinning the mixture into a filament and subsequently drawing the filament to obtain the required yarn properties. PMC yarn 12 exhibits better abrasion resistance as measured by the squirrel cage test. The abrasion resistance is at least 2 times (200%) and preferably 300% higher than a standard 100% PET yarn with similar tensile and shrinkage properties. Such a yarn used as a bottom weft of a forming fabric lowers the power consumption of the paper machine and/or allows the use of a higher vacuum to obtain a greater dry content in the product in the forming section. This is accomplished without sacrificing any other key functionalities of the fabric.

### Example 1

A 0.27 mm yarn was produced by blending PET with a polymeric siloxane Masterbatch and a polymeric compatibilizer in a single screw extruder (Yarn 1). The loading of the polymeric siloxane in the blend was approximately 5.4% and the polymeric carbodiimide was approximately 0.3%. The melt was then pumped through a spinneret connected to the extruder, quenched and drawn to the final diameter to achieve the required yarn specifications. The abrasion resistance of the yarn thus produced was measured using the squirrel cage method. The squirrel cage test consists of a rotating drum of metal wires which are aligned perpendicular to the polymer strands. At the beginning of the test, a load is applied to each strand. During the test the strands are continually abraded by the rotation of the drum and the strand's abrasion resistance is quantified by the number of cycles it takes for the strand to fail. The average cycles to break was found to be 16320. In contrast, a 100% PET commercial yarn (Yarn 2) processed with the same PET resin under similar conditions and meeting the same yarn property (Table 1) specifications has average cycles to break of 4460. Hence, the abrasion resistance was increased by more than 3.5 times (350%) by the addition of polymeric siloxane and the compatibilizer.

TABLE 1
Comparison of Yarn Properties

| | Yarn 1 | Yarn 2 |
|---|---|---|
| Formulation (wt %) | 94.3% PET | 100% PET |
| | 5.4% Polymeric siloxane | |
| | 0.3% Polymeric | |
| | carbodiimide | |
| Diameter (mm) | 0.27 | 0.27 |
| Tensile Strength (lbs) | 9 | 9 |
| Young's Modulus (gf/den) | 96 | 97 |
| Strain at Break (%) | 13 | 19 |
| Strain @ 1.75 gf/den (%) | 2.7 | 2.5 |
| Shrinkage @ 176.7° C. (%) | 15.5 | 15.2 |
| Abrasion Cycles to Break | 16320 | 4460 |

### Example 2

A 0.35 mm yarn was produced by blending PET with a polymeric siloxane masterbatch and a polymeric compatibilizer in a single screw extruder (Yarn 3). The loading of the polymeric siloxane in the blend was approximately 5.4% and the polymeric carbodiimide was approximately 0.3%. The melt was then pumped through a spinneret connected to the extruder, quenched and drawn to the final diameter to achieve the required yarn specifications. The abrasion resistance of the yarn thus produced was measured using the squirrel cage method. The coefficient of friction (COF) of the yarn was measured against a ceramic pin by applying a constant input tension and monitoring the output tension using a Constant Tension Transport-Dynamic Friction Tester (CTT-DTT) from Lawson Hemphill. The average cycles to break was found to be 35500 and the average COF value was 0.16. In contrast, a 100% PET commercial yarn (Yarn 4) processed with the same PET resin under similar processing conditions has average cycles to break of 3350 and an average COF value of 0.20. Hence, the abrasion resistance was increased by more than 10.5 times (1050%) and the average COF was decreased by 20% by the addition of polymeric siloxane and the compatibizer.

TABLE 2
Comparison of Yarn Properties

| | Yarn 3 | Yarn 4 |
|---|---|---|
| Formulation (wt %) | 94.3% PET | 100% PET |
| | 5.4% Polymeric siloxane | |
| | 0.3% Polymeric | |
| | carbodiimide | |
| Diameter (mm) | 0.35 | 0.35 |
| Tensile Strength (lbs) | 14 | 16 |
| Young's Modulus (gf/den) | 92 | 91 |
| Strain at Break (%) | 14 | 15 |
| Strain @ 1.75 gf/den (%) | 2.6 | 2.9 |
| Shrinkage @ 176.7° C. (%) | 14 | 11.5 |
| Abrasion Cycles to Break | 35500 | 3350 |
| Average COF | 0.16 | 0.20 |

During manufacture of PMC fabric yarn 12, a single screw extruder is used to melt blend a mixture of between 75% to 99% PET with 1% to 20% polymeric siloxane, preferably 2% to 6% polymeric siloxane, and 0.1% to 5% compatibilizer, preferably 0.1% to 1% (FIG. 2, block 14). A spinneret is then used to spin the mixture into a filament (block 16). The filament is then quenched, and subsequently drawn into a monofilament PMC fabric yarn with at least one predetermined physical property (blocks 18 and 20).

While this invention has been described with respect to at least two embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A paper machine clothing (PMC) fabric including a plurality of monofilament yarns, at least some of said yarns having a composition which is a mixture of between 75% to 99% polyethylene terephthalate (PET), 1% to 20% polymeric siloxane, and with a remainder of said composition being between 0.1% to 5% compatibilizer, and wherein said composition has an average coefficient of friction which is at least 10% less than said PET alone.

2. The PMC fabric of claim 1, wherein said composition includes between 2% to 6% polymeric siloxane.

3. The PMC fabric of claim 3, wherein said composition includes a compatibilizer of between 0.1% to 1%.

4. The PMC fabric of claim 3, wherein said compatibilizer is carbodiimide.

5. The PMC fabric of claim 1, wherein said composition has an average coefficient of friction which is at least approximately 20% less than said PET alone.

6. The PMC fabric of claim 1, wherein said composition has an abrasion resistance which is at least approximately 200% greater than said PET alone.

7. The PMC fabric of claim 1, wherein said composition has an abrasion resistance which is at least approximately 350% greater than said PET alone.

8. The PMC fabric of claim 1, wherein said yarns have a diameter of between approximately 0.05 mm and 0.9 mm.

9. The PMC fabric of claim 1, wherein said PMC fabric includes a plurality of woven yarns.

10. A paper machine clothing (PMC) fabric yarn for use in a PMC fabric, said PMC yarn having a composition which is a mixture of between 75% to 99% polyethylene terephthalate (PET), 1% to 20% polymeric siloxane, and with a remainder of said composition being between 0.1% to 5% compatibilizer, and wherein said composition has an average coefficient of friction which is at least 10% less than said PET alone.

11. The PMC fabric yarn of claim 10, wherein said composition includes between 2% to 6% polymeric siloxane.

12. The PMC fabric yarn of claim 12, wherein said composition includes a compatibilizer of between 0.1% to 1%.

13. The PMC fabric yarn of claim 12, wherein said compatibilizer is carbodiimide.

14. The PMC fabric of claim 1, wherein said composition has an average coefficient of friction which is at least approximately 20% less than said PET alone.

15. The PMC fabric yarn of claim 10, wherein said composition has an abrasion resistance which is at least approximately 200% greater than said PET alone.

16. The PMC fabric yarn of claim 10, wherein said composition has an abrasion resistance which is at least approximately 350% greater than said PET alone.

17. The PMC fabric yarn of claim 10, wherein said yarns have a diameter of between approximately 0.05 mm and 0.9 mm.

18. The PMC fabric yarn of claim 10, wherein said PMC fabric includes a plurality of woven yarns.

19. A method of manufacturing a paper machine clothing (PMC) fabric yarn for use in a PMC fabric, said method comprising the steps of:
melt blending a mixture of between 75% to 99% polyethylene terephthalate (PET), 1% to 20% polymeric siloxane, with a remainder of said mixture being between 0.1% to 5% compatibilizer;
spinning the mixture into a filament; and
drawing the filament into a monofilament PMC fabric yarn with at least one predetermined physical property.

20. The method of manufacturing a PMC fabric yarn of claim 19, wherein said mixture includes between 2% to 6% polymeric siloxane.

21. The method of manufacturing a PMC fabric yarn of claim 19, wherein said melt blending step uses a single screw extruder.

22. The method of manufacturing a PMC fabric yarn of claim 19, wherein said spinning step uses a spinneret.

23. The method of manufacturing a PMC fabric yarn of claim 19, including the step of quenching the filament between said spinning step and said drawing step.

24. The method of manufacturing a PMC fabric yarn of claim 19, wherein said predetermined physical property is average coefficient of friction which is at least approximately 10% less than said PET alone.

25. The method of manufacturing a PMC fabric yarn of claim 19, wherein said predetermined physical property is an abrasion resistance which is at least approximately 200% greater than said PET alone.

26. The method of manufacturing a PMC fabric yarn of claim 25, wherein said melt blending step includes melt blending the compatibilizer of between 0.1% to 1% into said mixture.

27. The method of manufacturing a PMC fabric yarn of claim 25, wherein said compatibilizer is carbodiimide.
